(19) United States
(12) Patent Application Publication
(10) Pub. No.: US 2015/0179043 A1
(43) Pub. Date: Jun. 25, 2015

(54) USER ALERT ON DEVICE ANTENNA BLOCKING

(71) Applicant: QUALCOMM Incorporated, San Diego, CA (US)

(72) Inventors: Venkata Siva Prasad Rao GUDE, Hyderabad (IN); Girish Venkata VADLAMUDI, Hyderabad (IN); Debesh Kumar SAHU, Hyderabad (IN)

(73) Assignee: QUALCOMM Incorporated, San Diego, CA (US)

(21) Appl. No.: 14/262,481

(22) Filed: Apr. 25, 2014

Related U.S. Application Data
(60) Provisional application No. 61/919,666, filed on Dec. 20, 2013.

(51) Int. Cl. G08B 21/18; H04B 17/00

(52) U.S. Cl. CPC G08B 21/182; H04B 17/0057

(57) ABSTRACT

A method, an apparatus, and a computer program product for wireless communication are provided. The apparatus may receive a signal at least at a first antenna and a second antenna, determine a first strength of the signal received at the first antenna and a second strength of the signal received at the second antenna, and alert a user when a difference between the first and second strengths exceeds a threshold. The difference between the first and second strengths may be caused by an obstruction of the first antenna or the second antenna. For example, the obstruction may be a hand or head of the user of the UE. The UE may also start a timer when the difference exceeds the threshold. The UE may also determine a sensitivity difference between the first and second antennas and adjust the difference between the first and second strengths based on the sensitivity difference.

### CROSS-REFERENCE TO RELATED APPLICATION(S)

This application claims the benefit of U.S. Provisional Application Ser. No. 61/919,666, entitled “USER ALERT ON DEVICE ANTENNA BLOCKING” and filed on Dec. 20, 2013, which is expressly incorporated by reference herein in its entirety.

### BACKGROUND

1. Field

The present disclosure relates generally to communication systems and, more particularly, to a device providing an alert to a user during antenna blocking.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

A user equipment (UE) may have multiple antennas. In MIMO technology, multiple antennas may be used by the UE for transmission and/or reception. In some circumstances, one or more of the antennas may be blocked. For example, the antenna may be blocked by the user's hand, the user's head, or the cover of the UE. When an antenna is blocked, the performance of transmissions and/or receptions of the UE may degrade. Performance degradation may lead to dropped calls, decreased data quality, increased transmission failures, and increased data re-transmissions. In an attempt to compensate for performance degradation, the UE may increase the amount of power used for transmissions. Accordingly, blocking an antenna of the UE may lead to decreased throughput and increased power consumption. These consequences may occur without the knowledge of the user of the UE. Providing an alert to the user may give the user an opportunity to take action to prevent further blocking of an antenna, thereby restoring the performance of the UE. Therefore, a need exists for a UE that alerts the user when an antenna of the UE is blocked.

### SUMMARY

In an aspect of the disclosure, a method, a computer program product, and an apparatus are provided. The apparatus may be a UE.

The method may include receiving a signal at least at a first antenna and a second antenna, determining a first strength of the signal received at the first antenna and a second strength of the signal received at the second antenna, and alerting a user when a difference between the first and second strengths exceeds a threshold. The alert may be a generated noise. The difference between the first and second strengths may be caused by an obstruction of the first antenna or the second antenna. The obstruction may be a head or a hand of the user. The obstruction may unequally affect the first and second strengths received at the first and second antennas, respectively. The distance between the first and second antennas may be greater than a dimension of the obstruction.

The computer program product may include a computer-readable medium having code for receiving a signal at least at a first antenna and a second antenna, code for determining a first strength of the signal received at the first antenna and a second strength of the signal received at the second antenna, and code for alerting a user when a difference between the first and second strengths exceeds a threshold.

In an aspect, the apparatus may include means for receiving a signal at least at a first antenna and a second antenna, means for determining a first strength of the signal received at the first antenna and a second strength of the signal received at the second antenna, and means for alerting a user when a difference between the first and second strengths exceeds a threshold.

In another aspect, the apparatus may include a memory and at least one processor coupled to the memory and configured to receive a signal at least at a first antenna and a second antenna, determine a first strength of the signal received at the first antenna and a second strength of the signal received at the second antenna, and alert a user when a difference between the first and second strengths exceeds a threshold.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating an example of a communication system having a transmitter and a receiver.

FIGS. 8A and 8B are diagrams illustrating the signal strengths of the antennas of the receiver with respect to time.

FIG. 9 is a diagram illustrating the difference between a strength of a signal received at a first antenna and a strength of a signal received at a second antenna with respect to time.

FIG. 10 is a diagram illustrating the difference between a strength of a signal received at a first antenna and a strength of a signal received at a second antenna with respect to time.

FIG. 11 is a flow chart illustrating a method of wireless communication.

FIG. 12 is a flow chart illustrating a method of wireless communication.

FIG. 13 is a conceptual data flow diagram illustrating the data flow between different modules/means/components in an exemplary apparatus.

FIG. 14 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

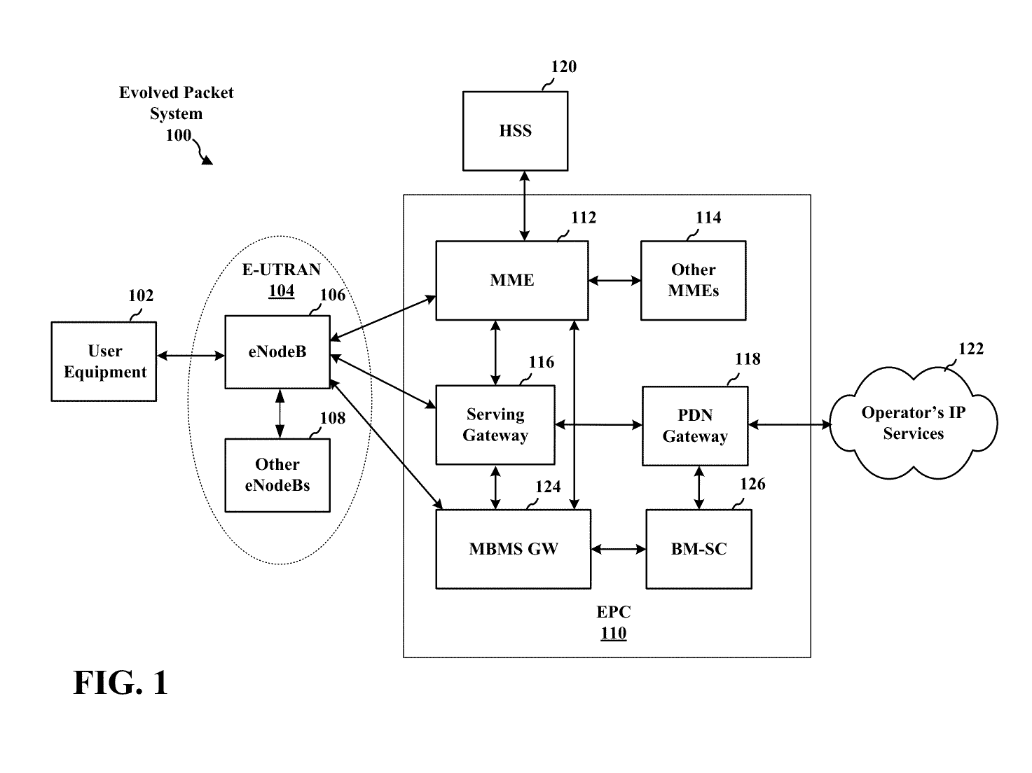

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS). The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

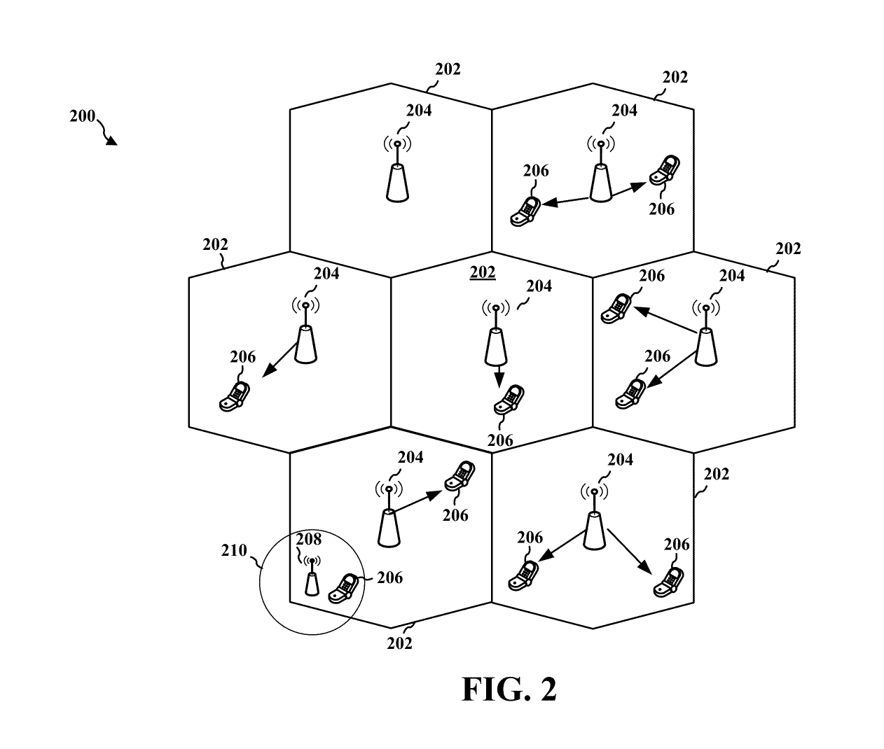

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sector). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

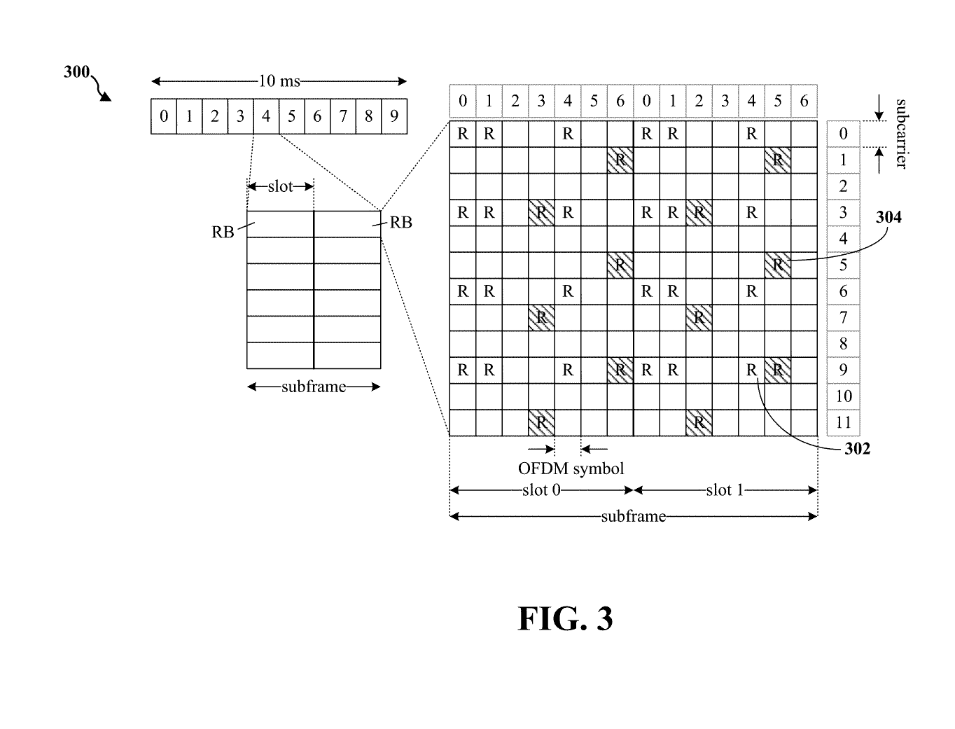

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

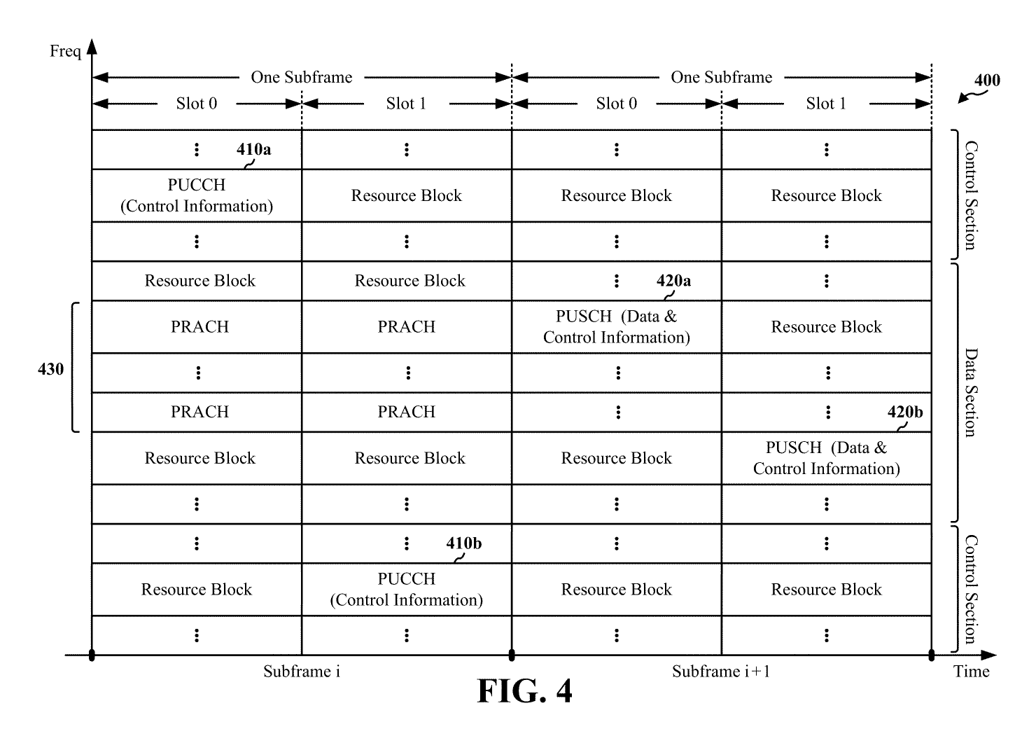

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

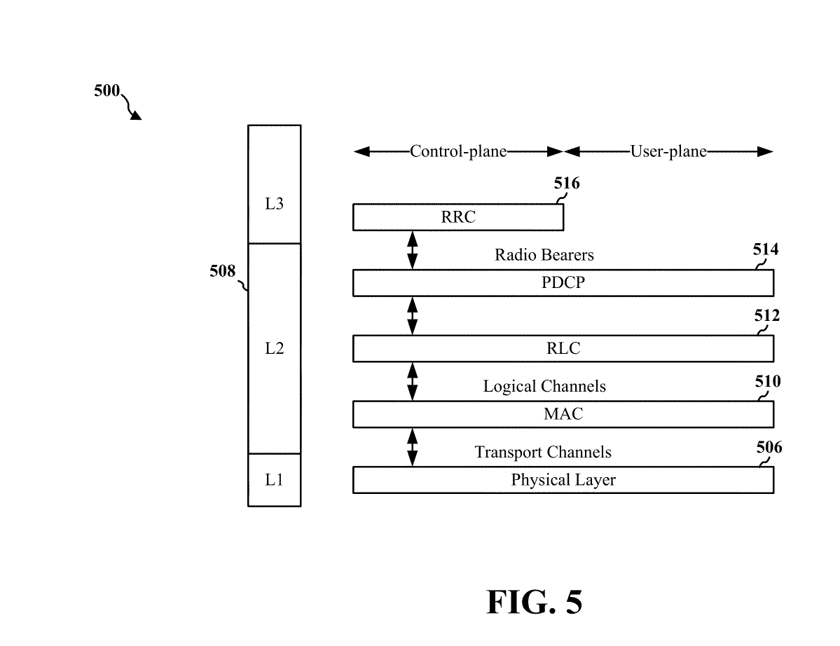

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

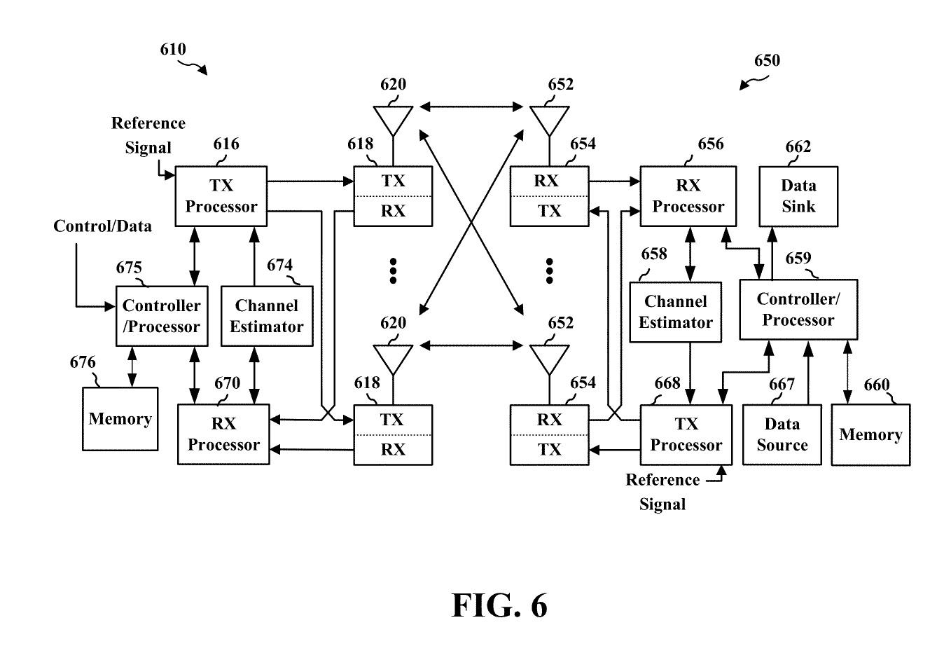

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

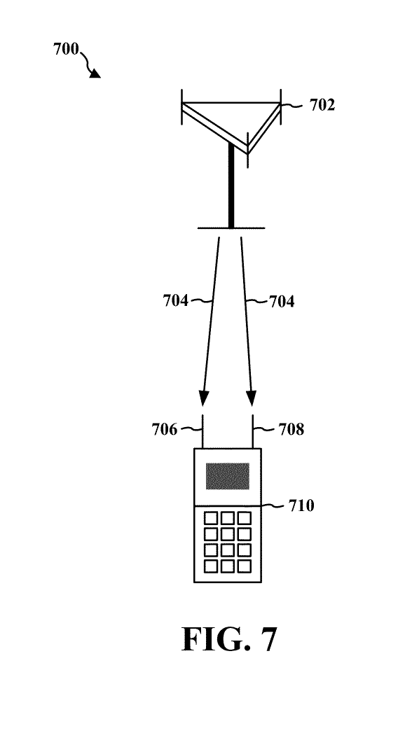

FIG. 7 is a diagram illustrating a communication system 700. The communication system 700 includes a transmitter 702 and a receiver 710. In an aspect, the transmitter 702 is an eNB, and the receiver 710 is a UE. In an aspect, the receiver 710 may have at least two antennas (e.g., antenna 706 and antenna 708). However, one of ordinary skill in the art will appreciate that the receiver 710 may be configured to have more than two antennas without deviating from the scope of the present disclosure. The antennas 706 and 708 may be configured in various regions of the receiver 710.

In an aspect, the antennas 706 and 708 may be configured to receive signals of the same radio access technology (RAT) or of different RATs. For example, after receiving a signal 704 from the transmitter 702, the receiver 710 may determine whether the first antenna 706 and the second antenna 708 are tracking the same RAT, channel, and/or band. Upon determining that the first antenna 706 and the second antenna 708 are tracking the same RAT, channel, and/or band, the receiver 710 may register an interrupt or call-back application programming interface (API) with RF software. For example, in the case of a 2×2 MIMO-capable LTE/UMTS receiver 710, the receiver 710 may have 2 RX antennas and 2 TX antennas or, alternatively, 2 RX/TX antennas.

In an aspect, the antennas 706 and 708 may have equal or unequal sensitivities with respect to different RF chains. The receiver 710 may have multiple subscriber identity modules (SIMs), such as a device referred to by those skilled in the art as dual-system dual-standby (DSDS), dual-system dual-active (DSDA), tri-system dual-standby (TSTS), or tri-system dual-active (TSDA). If the receiver 710 is a multiple-SIM device, two or more SIMs of the receiver 710 may be monitoring the same channel and/or the same band. Accordingly, the RF performance of at least two antennas (e.g., antenna 706 and antenna 708) of the receiver 710 may be measured.

In an aspect, the transmitter 702 may transmit a signal 704 and the receiver 710 may receive the signal 704 at least at antenna 706 and antenna 708. The receiver 710 may determine the strength of the signal 704 received at antenna 706 and the strength of the signal 704 received at antenna 708. Signal strength may be measured according to a received signal strength indicator (RSSI), automatic gain control (AGC), or other similar measurements or parameters. Signal strength may be quantified in units of dBm (also referred to as dBmW), which correspond to the power ratio in decibels (dB) of the measured power with reference to one milliwatt (mW).

In some circumstances, the strength of the signal 704 received at antenna 706 may differ from the strength of the signal 704 received at antenna 708 due to an obstruction of antenna 706 or antenna 708. For example, the obstruction may be the head of the user, the hand of the user, a cover of the receiver 710, or any other object that may obstruct the path of a wireless signal. In other circumstances, both antennas 706 and 708 may be obstructed by a single obstruction such that the single obstruction unequally reduces the strength of the signals 704 received at antennas 706 and 708. For example, the obstruction may have a dimension that is smaller than the distance between antenna 706 and antenna 708 such that the obstruction obstructs one antenna (e.g., antenna 706) without equally obstructing another antenna (e.g., antenna 708). When the difference between the strength of the signal 704 received at antenna 706 and the strength of the signal 704 received at antenna 708 exceeds a threshold, the receiver 710 may alert the user of the receiver 710. The threshold may be preconfigured at the receiver 710, determined by the receiver 710 based on environmental conditions, and/or set by the transmitter 702. However, one of ordinary skill in the art will appreciate that the threshold may be set using other techniques. The alert may be an auditory indication (e.g., a noise), a haptic indication (e.g., a vibration), a visual indication (e.g., a displayed notification or displayed performance statistics), or any combination thereof. In an aspect, the alert may be a single alert with a limited duration or a continuous alert. However, one of ordinary skill in the art will appreciate that other types and/or configurations of the alert may be implemented without deviating from the scope of the present disclosure.

In response to the alert provided by the receiver 710, the user may take action to remove or reduce any obstructions that block antenna 706 and/or antenna 708 and which may be causing a reduction in the strength of the signal 704 received at antenna 706 and/or antenna 708. For example, upon receiving an alert, the user may move or reposition his hand or head on the receiver 710 such that the effect of the obstruction on antenna 706 and/or antenna 708 is reduced. As a result, the strength of the signal 704 received at antenna 706 and/or antenna 708 may no longer be reduced and the performance of the receiver 710 may be improved.

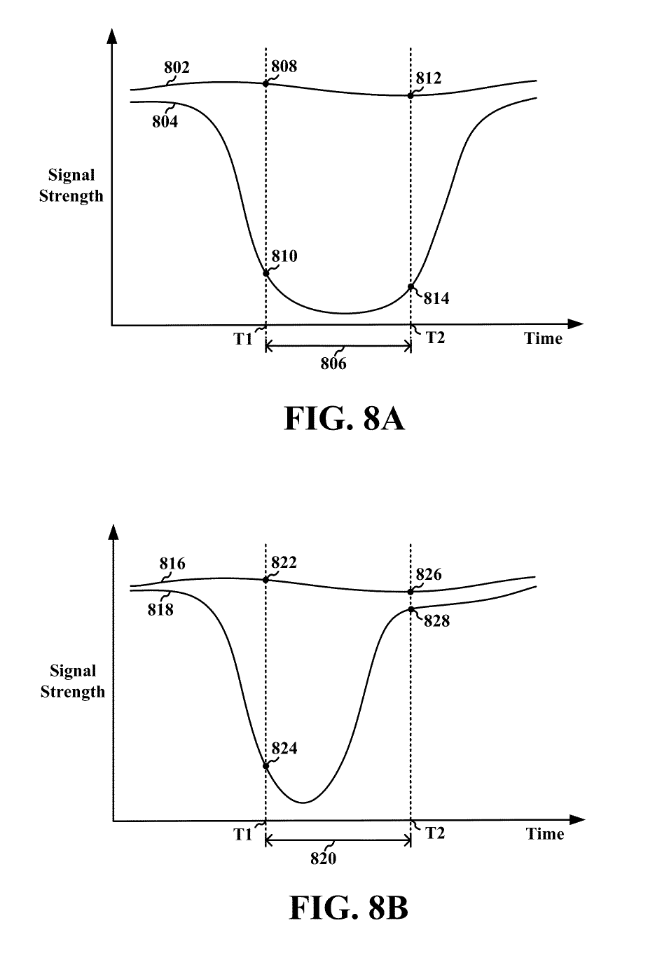

FIGS. 8A and 8B are diagrams illustrating the signal strengths of the antennas of the receiver with respect to time. Lines 802 and 816 represent the strength of the signal 704 received by one antenna (e.g., antenna 706), and lines 804 and 818 represent the strength of the signal 704 received by another antenna (e.g., antenna 708). In an aspect, the difference between the strength of the signal 704 received at antenna 706 and the strength of the signal 704 received at antenna 708 may equal (or exceed) a threshold. With reference to FIG. 8A, the threshold may be equal to the difference between point 808 on line 802 and point 810 on line 804. With reference to FIG. 8B, the threshold may be equal to the difference between point 822 on line 816 and point 824 on line 818. With reference to FIGS. 8A and 8B, at time T1, the difference between the strength of the signal 704 received at antenna 706 and the strength of the signal 704 received at antenna 708 equals (or exceeds) the threshold. In an aspect, when the difference equals (or exceeds) the threshold, a timer may be started. For example, the timer may be a hysteresis timer. With reference to FIG. 8A, the timer may begin at time T1, have a time period 806, and expire at time T2. With reference to FIG. 8B, the timer may begin at time T1, have a time period 820, and expire at time T2.

With reference to FIG. 8A, when the timer expires at time T2, the difference between point 812 on line 802 and point 814 on line 804 represents the difference between the strength of the signal 704 received at antenna 706 and the strength of the signal 704 received at antenna 708. In an aspect, the difference between point 812 on line 802 and point 814 on line 804 equals the threshold. Accordingly, when the timer expires at time T2, the difference between the strength of the signal 704 received at antenna 706 and the strength of the signal 704 received at antenna 708 equals the threshold. In such an aspect, the receiver 710 may alert the user at time T2.

With reference to FIG. 8B, when the timer expires at time T2, the difference between point 826 on line 816 and point 828 on line 818 represents the difference between the strength of the signal 704 received at antenna 706 and the strength of the signal 704 received at antenna 708. In an aspect, the difference between point 826 on line 816 and point 828 on line 818 is less than the threshold. Accordingly, when the timer expires at time T2, the difference between the strength of the signal 704 received at antenna 706 and the strength of the signal 704 received at antenna 708 is less than the threshold. In such an aspect, the receiver 710 may not alert the user at time T2.

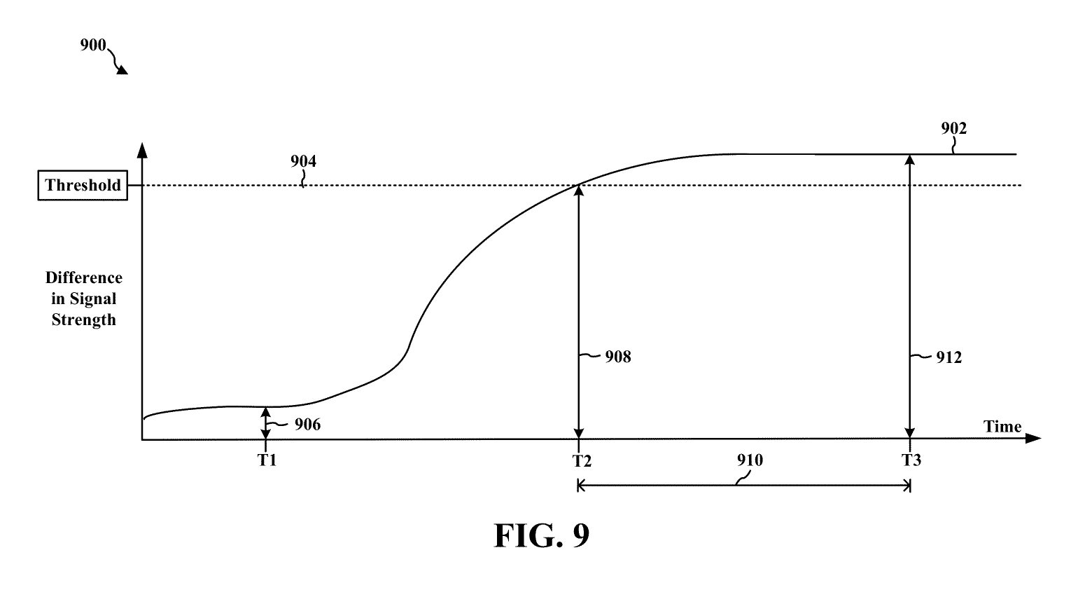

FIG. 9 is a diagram 900 illustrating the difference (e.g., line 902) between the strength of the signal 704 received at antenna 706 and the strength of the signal 704 received at antenna 708 with respect to time. At time T1, the difference 906 between the strength of the signal 704 received at antenna 706 and the strength of the signal 704 received at antenna 708 is below the threshold 904. At time T2, the difference 908 between the strength of the signal 704 received at antenna 706 and the strength of the signal 704 received at antenna 708 equals (or exceeds) the threshold 904. In an aspect, the receiver 710 may be configured to immediately alert the user when the threshold 904 is reached (or exceeded).

In another aspect, the receiver 710 may refrain from immediately alerting the user when the threshold 904 is reached (or exceeded). In such an aspect, the receiver 710 may start a timer (e.g., a hysteresis timer) when the difference between the strength of the signal 704 received at antenna 706 and the strength of the signal received at antenna 708 equals (or exceeds) the threshold 904. For example, the receiver 710 may start the timer at time T2. The timer may have a time period 910 and may expire at time T3. If the difference between the strength of the signal 704 received at antenna 706 and the strength of the signal 704 received at antenna 708 exceeds the threshold 904 upon expiration of the timer (e.g., at time T3), the receiver 710 may alert the user. In the configuration of FIG. 9, since the difference 912 between the strength of the signal 704 received at antenna 706 and the strength of the signal 704 received at antenna 708 exceeds the threshold 904 at time T3, the receiver 710 alerts the user.

In an aspect, the timer may be preconfigured with a fixed duration or configured with a variable duration. In an aspect, the receiver 710 may stop the timer or may reset the timer when the receiver 710 is in a particular mode, such as an airplane mode and/or an out of service mode. In an aspect, the receiver 710 may start the timer when the receiver 710 enters an online mode.

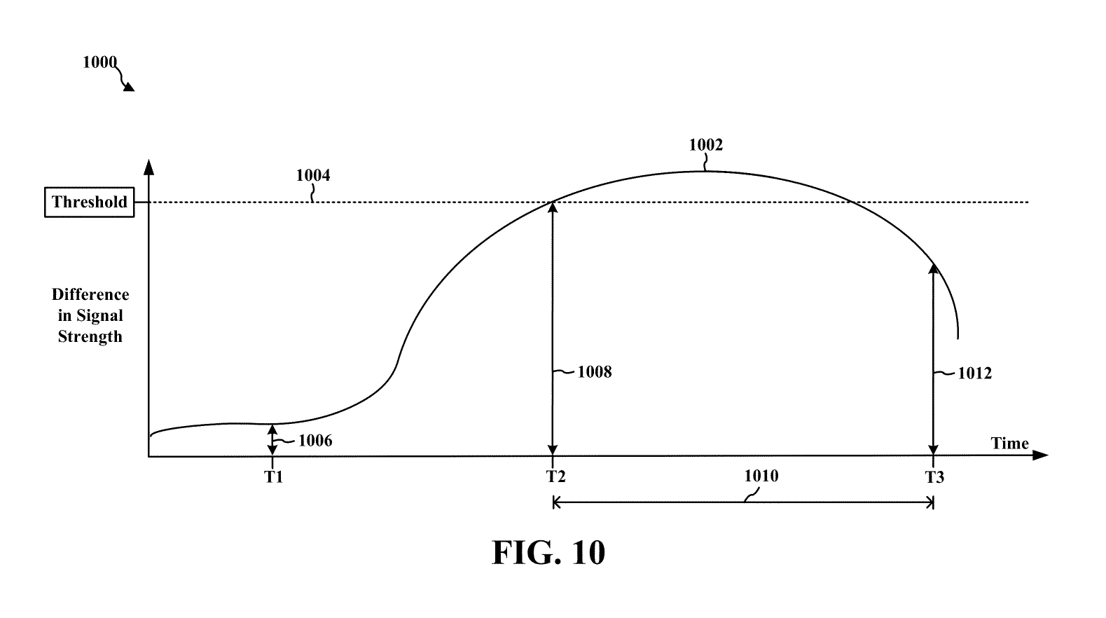

FIG. 10 is a diagram 1000 illustrating the difference (e.g., line 1002) between the strength of the signal 704 received at antenna 706 and the strength of the signal 704 received at antenna 708 with respect to time. At time T1, the difference 1006 between the strength of the signal 704 received at antenna 706 and the strength of the signal 704 received at antenna 708 is below the threshold 1004. At time T2, the difference 1008 between the strength of the signal 704 received at antenna 706 and the strength of the signal 704 received at antenna 708 equals (or exceeds) the threshold 1004. In an aspect, the receiver 710 may be configured to immediately alert the user when the threshold 1004 is reached (or exceeded).

In an aspect, the receiver 710 may refrain from immediately alerting the user when the threshold 1004 is reached (or exceeded). In such an aspect, the receiver 710 may start a timer (e.g., a hysteresis timer) when the difference between the strength of the signal 704 received at antenna 706 and the strength of the signal 704 received at antenna 708 equals (or exceeds) the threshold 1004. For example, the receiver 710 may start the timer at time T2. The timer may have a time period 1010 and may expire at time T3. If the difference between the strength of the signal 704 received at antenna 706 and the strength of the signal 704 received at antenna 708 is less than the threshold 1004 upon expiration of the timer (e.g., at time T3), the receiver 710 may refrain from alerting the user. In the aspect of FIG. 10, the difference 1012 between the strength of the signal 704 received at antenna 706 and the strength of the signal 704 received at antenna 708 at time T3 is less than the threshold 1004. Accordingly, in such an aspect, the receiver 710 refrains from alerting the user.

In an aspect, the alert may be a continuous notification that begins when the difference in signal strength between antenna 706 and antenna 708 exceeds the threshold and ends when the difference in signal strength between antenna 706 and antenna 708 no longer exceeds the threshold. For example, the receiver 710 may provide a continuous notification to the user starting at time T2 (e.g., when the difference 1008 in signal strength between antenna 706 and antenna 708 exceeds the threshold) and ending prior to time T3 (e.g., when the difference 1012 in signal strength between antenna 706 and antenna 708 no longer exceeds the threshold).

In some configurations, the receiver 710 may determine the sensitivity difference between antenna 706 and antenna 708 and may adjust the difference between the signal strengths of antenna 706 and antenna 708 based on the sensitivity difference. For example, the sensitivity difference of antenna 708 relative to antenna 706 may be −5 dBm. When the receiver 710 determines the difference between the signal strengths of antenna 706 and antenna 708, the receiver 710 may adjust the determined difference between the signal strengths by the sensitivity difference. For example, if the receiver 710 determines that the difference between the signal strength of antenna 706 and antenna 708 is 20 dBm, the receiver 710 may adjust that difference to 15 dBm based on the sensitivity difference of −5 dBm (e.g., 20 dBm−5 dBm=15 dBm). If the adjusted difference between the signal strengths of antenna 706 and antenna 708 (e.g., 15 dBm) exceeds the threshold 1004, the receiver 710 may alert the user.

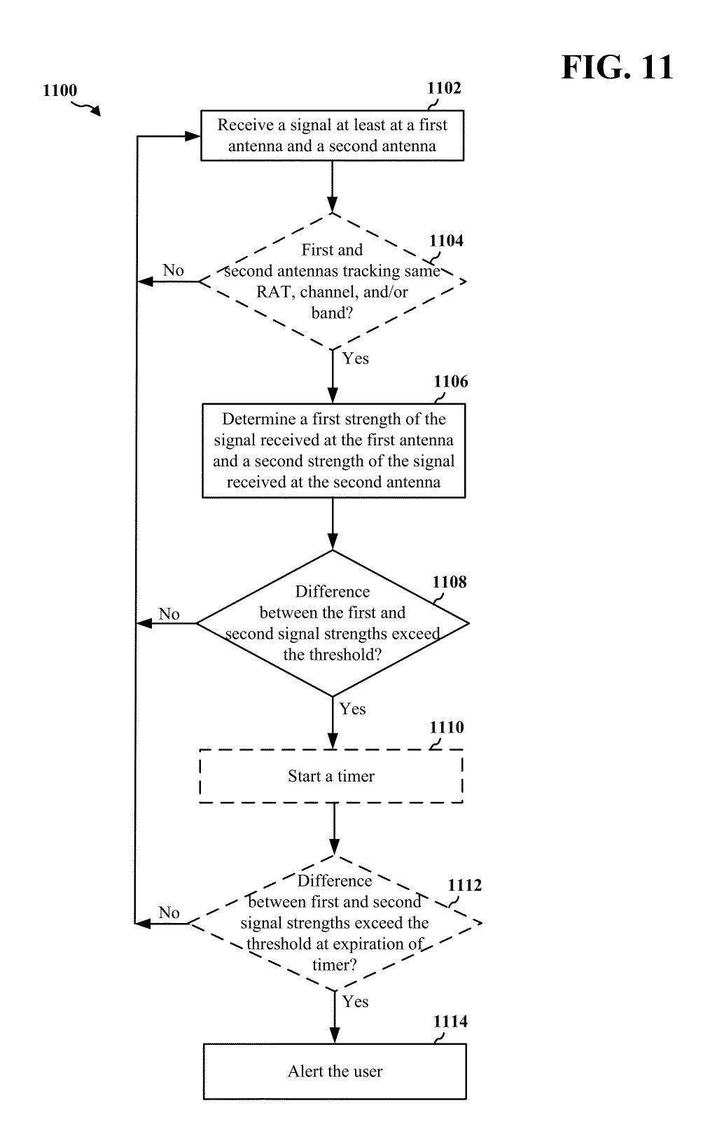

FIG. 11 is a flow chart 1100 illustrating a method of wireless communication. The method may be performed by a receiver, such as the receiver 710. At step 1102, the receiver 710 receives a signal at least at a first antenna and a second antenna. For example, referring to FIG. 7, the receiver receives a signal 704 at least at antenna 706 and antenna 708.

At step 1104, the receiver determines whether the first antenna and the second antenna are tracking the same RAT, channel, and/or band. If the first antenna and the second antenna are tracking the same RAT, channel, and/or band, then at step 1106, the receiver determines a first strength of the signal received at the first antenna and a second strength of the signal received at the second antenna. For example, referring to FIG. 7, the receiver 710 determines the strength of the signal 704 received at antenna 706 and the strength of the signal 704 received at antenna 708. Otherwise, if the first antenna and the second antenna are not tracking the same RAT, channel, and/or band, the receiver performs step 1102.

At step 1108, the receiver determines whether the difference between the first and second signal strengths exceeds a threshold. For example, with reference to FIG. 7, an obstruction of antenna 706 or antenna 708 may cause a difference between the signal strengths at antenna 706 and antenna 708. For example, referring to FIG. 9, the receiver 710 determines whether the difference between the strength of the signal 704 received at antenna 706 and the strength of the signal 704 received at antenna 708 exceeds the threshold 904.

If the difference between the first and second signal strengths exceeds the threshold (step 1108), then at step 1110, the receiver starts a timer (e.g., a hysteresis timer). For example, referring to FIGS. 9 and 10, the receiver 710 starts a timer at time T2. At time T2, the difference (e.g., difference 908 or difference 1008) between the strength of the signal 704 received at antenna 706 and the strength of the signal 704 received at antenna 708 equals or exceeds the threshold (e.g., threshold 904 or threshold 1004). After a time period (e.g., time period 910 or time period 1010), the timer expires at time T3.

At step 1112, the receiver determines whether the difference between the first and second signal strengths exceeds the threshold at the expiration of the timer. For example, referring to FIGS. 9 and 10, the timer expires at time T3. In FIG. 9, at time T3, the difference 912 exceeds the threshold 904. In FIG. 10, at time T3, the difference 1012 does not exceed the threshold 1004. If the difference between the first and second signal strengths exceeds the threshold at expiration of the timer (step 1112), then at step 1114, the receiver alerts the user. Otherwise, the receiver performs step 1102.

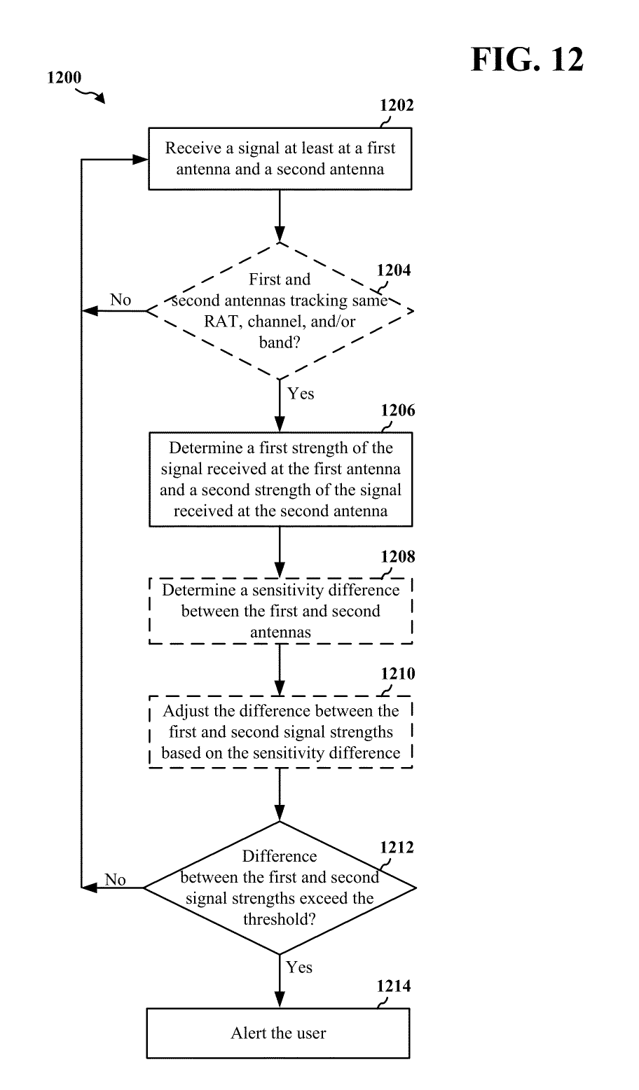

FIG. 12 is a flow chart 1200 illustrating a method of wireless communication. The method may be performed by a receiver, such as the receiver 710. At step 1204, the receiver receives a signal at least at a first antenna and a second antenna. At step 1202, the receiver determines whether the first antenna and the second antenna are tracking the same RAT, channel, and/or band. If the first antenna and the second antenna are tracking the same RAT, channel, and/or band, then at step 1206, the receiver determines a first strength of the signal received at the first antenna and a second strength of the signal received at the second antenna. For example, referring to FIG. 7, the receiver 710 determines the strength of the signal 704 received at antenna 706 and the strength of the signal 704 received at antenna 708. Otherwise, if the first antenna and the second antenna are not tracking the same RAT, channel, and/or band, the receiver performs step 1202.

At step 1208, the receiver determines a sensitivity difference between the first antenna and the second antenna. For example, referring to FIG. 7, the receiver 710 may determine the sensitivity difference between antenna 708 relative to antenna 706 to be −5 dBm.

At step 1210, the receiver adjusts the difference between the first and second signal strengths based on the sensitivity difference. For example, referring to FIG. 7, if the receiver 710 determines that the difference between the strength of the signal 704 received at antenna 706 and the strength of the signal 704 received at antenna 708 is 20 dBm, the receiver 710 may adjust that difference to 15 dBm based on the sensitivity difference of −5 dBm (e.g., 20 dBm−5 dBm=15 dBm). At step 1212, the receiver determines whether the adjusted difference between the first and second signal strengths exceeds the threshold. For example, referring to FIG. 7, the receiver 710 determines whether the adjusted difference between the strength of the signal 704 received at antenna 706 and the strength of the signal 704 received at antenna 708 (e.g., 15 dBm) exceeds the threshold. If so, then at step 1214, the receiver alerts the user. Otherwise, the receiver performs step 1202.

It should be understood that the steps included by dotted lines in FIGS. 11 and 12 represent optional steps. For example, steps 1102, 1106, 1108, and 1114 can be performed without performing steps 1104, 1110, and/or 1112. As another example, steps 1202, 1206, 1212, and 1214 can be performed without performing steps 1204, 1208, and/or 1210.

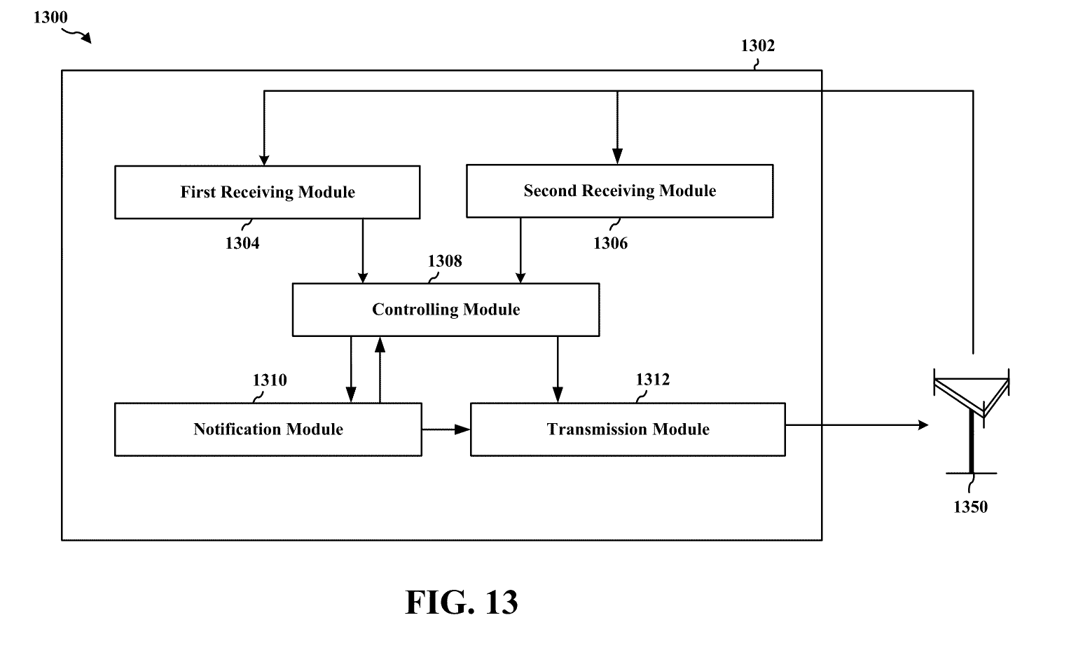

FIG. 13 is a conceptual data flow diagram 1300 illustrating the data flow between different modules/means/components in an exemplary apparatus 1302. The apparatus 1302 may be a receiver, such as a UE. The apparatus 1302 includes a first receiving module 1304, a second receiving module 1306, a controlling module 1308, a notification module 1310, and a transmission module 1312.

The first receiving module 1304 may be configured to receive a signal at a first antenna. The second receiving module 1306 may be configured to receive the same signal at a second antenna. The controlling module 1308 may be configured to determine a first strength of the signal received at the first antenna and a second strength of the signal received at the second antenna. The notification module 1310 may be configured to alert a user when a difference between the first and second signal strengths exceeds a threshold.

The controlling module 1308 may be further configured to start a timer when the difference between the first and second signal strengths exceeds the threshold. In some configurations, the user is alerted when the difference exceeds the threshold upon expiration of the timer. In some configurations, the user is not alerted when the difference does not exceed the threshold upon expiration of the timer.

The controlling module 1308 may be further configured to determine a sensitivity difference between the first and second antennas and adjust the difference between the first and second strengths based on the sensitivity difference, wherein the user is alerted when the adjusted difference exceeds the threshold.

In some configurations, the difference between the first and second strengths is caused by an obstruction of the first antenna or the second antenna. The obstruction may be a head of the user or a hand of the user. The obstruction may unequally affect the first and second strengths. A distance between the first and second antennas may be greater than a dimension of the obstruction.

In some configurations, alert generated by the notification module 1310 may include generating a noise. In some other configurations, the alert may include providing a continuous notification to the user when the difference between the first and second signal strengths exceeds the threshold and no longer providing the continuous notification when the difference between the first and second signal strengths does not exceed the threshold. In some configurations, the first and second antennas may be configured to receive signals based on a same radio access technology.

The apparatus may include additional modules that perform each of the steps of the algorithm in the aforementioned flow charts of FIGS. 11 and 12. As such, each step in the aforementioned flow charts of FIGS. 11 and 12 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

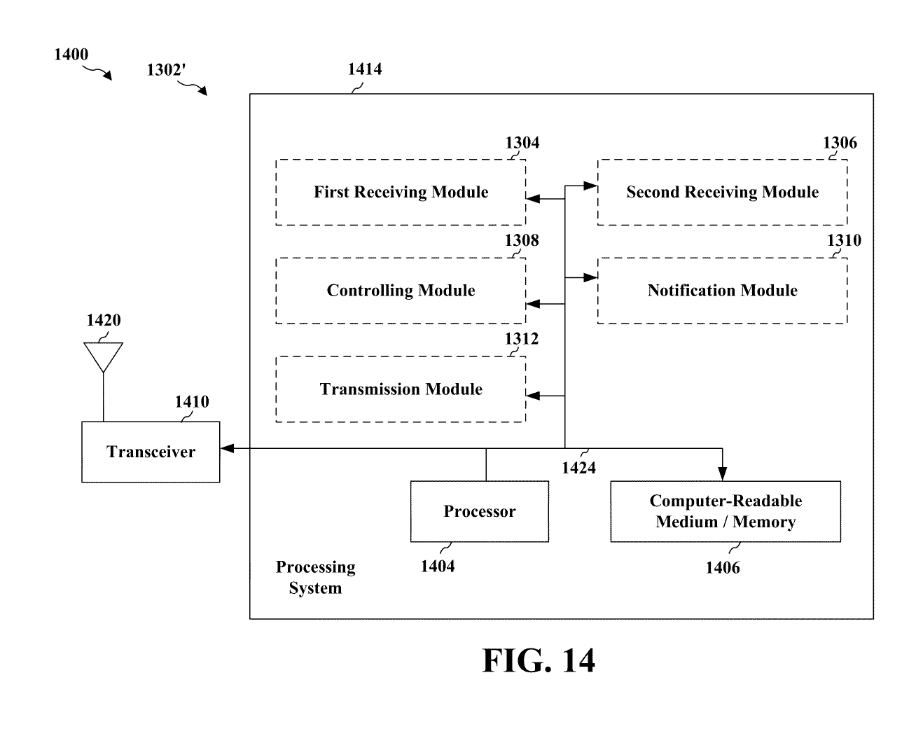

FIG. 14 is a diagram 1400 illustrating an example of a hardware implementation for an apparatus 1302′ employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware modules, represented by the processor 1404, the modules 1304, 1306, 1308, 1310, and 1312, and the computer-readable medium/memory 1406. The bus 1424 may also link various other circuits such as timing sources, peripherals, voltage regulators, and power management circuits, which are well known in the art, and therefore, will not be described any further.

The processing system 1414 may be coupled to a transceiver 1410. The transceiver 1410 is coupled to one or more antennas 1420. The transceiver 1410 provides a means for communicating with various other apparatus over a transmission medium. The transceiver 1410 receives a signal from the one or more antennas 1420, extracts information from the received signal, and provides the extracted information to the processing system 1414, specifically the receiving modules 1304, 1306. In addition, the transceiver 1410 receives information from the processing system 1414, specifically the transmission module 1312, and based on the received information, generates a signal to be applied to the one or more antennas 1420. The processing system 1414 includes a processor 1404 coupled to a computer-readable medium/memory 1406. The processor 1404 is responsible for general processing, including the execution of software stored on the computer-readable medium/memory 1406. The software, when executed by the processor 1404, causes the processing system 1414 to perform the various functions described supra for any particular apparatus. The computer-readable medium/memory 1406 may also be used for storing data that is manipulated by the processor 1404 when executing software. The processing system further includes at least one of the modules 1304, 1306, 1308, 1310, 1312. The modules may be software modules running in the processor 1404, resident/stored in the computer readable medium/memory 1406, one or more hardware modules coupled to the processor 1404, or some combination thereof. The processing system 1414 may be a component of the UE 650 and may include the memory 660 and/or at least one of the TX processor 668, the RX processor 656, and the controller/processor 659.

In one configuration, the apparatus 1302/1302′ for wireless communication may be a UE. The UE may include a means for receiving a signal at least at a first antenna and a second antenna. The UE may also include a means for determining a first strength of the signal received at the first antenna and a second strength of the signal received at the second antenna. The UE may also include a means for alerting a user when a difference between the first and second strengths exceeds a threshold. The UE may also include a means for starting a timer when the difference exceeds the threshold. The UE may also include a means for determining a sensitivity difference between the first and second antennas. The UE may also include a means for adjusting the difference between the first and second strengths based on the sensitivity difference.

The aforementioned means may be one or more of the aforementioned modules of the apparatus 1302 and/or the processing system 1414 of the apparatus 1302′ configured to perform the functions recited by the aforementioned means. As described supra, the processing system 1414 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method, comprising:
receiving a signal at least at a first antenna and a second antenna;
determining a first strength of the signal received at the first antenna and a second strength of the signal received at the second antenna; and
alerting a user when a difference between the first and second strengths exceeds a threshold.

2. The method of claim 1, further comprising:
starting a timer when the difference exceeds the threshold.

3. The method of claim 2, wherein the user is alerted when the difference exceeds the threshold upon expiration of the timer.

4. The method of claim 2, wherein the user is not alerted when the difference does not exceed the threshold upon expiration of the timer.

5. The method of claim 1, further comprising:
determining a sensitivity difference between the first and second antennas; and
adjusting the difference between the first and second strengths based on the sensitivity difference, wherein the user is alerted when the adjusted difference exceeds the threshold.

6. The method of claim 1, wherein the difference between the first and second strengths is caused by an obstruction of the first antenna or the second antenna.

7. The method of claim 1, wherein the alerting comprises providing a continuous notification to the user when the difference exceeds the threshold and no longer providing the continuous notification when the difference does not exceed the threshold.

8. The method of claim 1, wherein the first and second antennas are configured to receive signals based on a same radio access technology.

9. An apparatus, comprising:
means for receiving a signal at least at a first antenna and a second antenna;
means for determining a first strength of the signal received at the first antenna and a second strength of the signal received at the second antenna; and
means for alerting a user when a difference between the first and second strengths exceeds a threshold.

10. The apparatus of claim 9, further comprising:
means for starting a timer when the difference exceeds the threshold, wherein the user is alerted when the difference exceeds the threshold upon expiration of the timer, and wherein the user is not alerted when the difference does not exceed the threshold upon expiration of the timer.

11. The apparatus of claim 9, further comprising:
means for determining a sensitivity difference between the first and second antennas; and
means for adjusting the difference between the first and second strengths based on the sensitivity difference, wherein the user is alerted when the adjusted difference exceeds the threshold.

12. The apparatus of claim 9, wherein the means for alerting is configured to provide a continuous notification to the user when the difference exceeds the threshold and to no longer provide the continuous notification when the difference does not exceed the threshold.

13. An apparatus, comprising:
a memory; and
at least one processor coupled to the memory and configured to:
receive a signal at least at a first antenna and a second antenna;
determine a first strength of the signal received at the first antenna and a second strength of the signal received at the second antenna; and
alert a user when a difference between the first and second strengths exceeds a threshold.

14. The apparatus of claim 13, wherein the at least one processor is further configured to start a timer when the difference exceeds the threshold.

15. The apparatus of claim 13, wherein the at least one processor is configured to alert a user by providing a continuous notification to the user when the difference exceeds the threshold and by no longer providing the continuous notification when the difference does not exceed the threshold.

16. The apparatus of claim 13, wherein the at least one processor is further configured to:
determine a sensitivity difference between the first and second antennas; and
adjust the difference between the first and second strengths based on the sensitivity difference, wherein the at least one processor is configured to alert the user when the adjusted difference exceeds the threshold.

17. A computer program product, comprising:
a computer-readable medium comprising code for:
receiving a signal at least at a first antenna and a second antenna;
determining a first strength of the signal received at the first antenna and a second strength of the signal received at the second antenna; and
alerting a user when a difference between the first and second strengths exceeds a threshold.

18. The computer program product of claim 17, wherein the computer-readable medium further comprises code for starting a timer when the difference exceeds the threshold.

19. The computer program product of claim 17, wherein the alerting comprises providing a continuous notification to the user when the difference exceeds the threshold and no longer providing the continuous notification when the difference does not exceed the threshold.

20. The computer program product of claim 17, wherein the computer-readable medium further comprises code for:
determining a sensitivity difference between the first and second antennas; and
adjusting the difference between the first and second strengths based on the sensitivity difference, wherein the user is alerted when the adjusted difference exceeds the threshold.
